(19) United States
(12) Patent Application Publication
(10) Pub. No.: US 2026/0267291 A1
(43) Pub. Date: Sep. 10, 2026

(54) ASSEMBLY DEVICE, METHOD, BRACELET AND WATCH

(71) Applicant: ROLEX SA, Genève 26 (CH)

(72) Inventors: Annick BAUR, GENEVA 26 (CH); Jérôme KREBS, Geneva 26 (CH)

(21) Appl. No.: 19/161,117

(22) PCT Filed: Jul. 4, 2024
(86) PCT No.: PCT/EP2024/068819

§ 371 Date: Aug. 29, 2025

(30) Foreign Application Priority Data
Jul. 6, 2023 (EP) 23183795.6

(51) Int. Cl. G04B 37/14; A44C 5/10; A44C 5/14

(52) U.S. Cl. CPC G04B 37/1486; A44C 5/105; A44C 5/14

(57) ABSTRACT

The invention relates to an assembly device, a method for obtaining an assembly device, a bracelet and a watch. An assembly device (10) for pivotally attaching at least two parts of a watch comprises a first part (1) and a pin (P) having means (7) to be mechanically connected to a second part (2). The first part (1) has a first friction surface (4) and the pin (P) has a second friction surface (5). The first friction surface (4) and the second friction surface (5) contact each other during pivoting movement. One of the friction surfaces (4, 5) has a surface hardness which is higher than the surface hardness of silica and/or feldspar. The other one of the friction surfaces (4, 5) has a surface hardness which is lower than the surface hardness of silica and/or feldspar. Effects of wear and stretch can be significantly reduced in this way.

The invention relates to an assembly device, a method for obtaining an assembly device, a bracelet and a watch.

Bracelets (wristbands) of watches, in particular made of metal, comprise articulated bracelet links. Two adjacent bracelet links are pivotally (rotatably) attached to each other through a bracelet pin so that a plurality of articulations (joints) are formed.

When worn, the joints wear out over time and the bracelet experiences stretch which may comprise an increase in length and/or a loss of tension (“sagging”). These degradations can make a bracelet uncomfortable to wear and significantly change its visual appearance.

The degradation of bracelet joints is caused by many factors, the abrasive dust particles being one of them. These particles penetrate into joints during everyday use of a bracelet watch. The particles are naturally present in the environment, issuing from natural processes like rocks' erosion and from human activities like extraction mining, building construction etc. The abrasive particles are mostly composed of silica and/or feldspar which are the most abundant minerals in the Earth's crust.

It is known in the prior art that bracelet links made of hard materials or surface-hardened metals increase the scratch resistance of these parts and thus reduce aesthetic degradation over time. Little information exists regarding wear and tear of the bracelet joints and its consequences for wearer comfort and aesthetics.

Document EP 2 057 914 A1 proposes specific materials identified for their compatibility to rub against each other. Minimum wear is achieved by arranging bearings having a high hardness between hinge pins and grooves of the link. Document EP 0 243 315 A1 proposes to arrange intermediate components between the hinge pin and the link in the form of bearings made of ruby or similar material to reduce wear on the joints of a strap. This solution requires additional elements to fix the bearings, as well as additional steps to assemble the links. Document JP 2003 038218 A describes a stainless-steel hinge pin for watch bands the surface of which is surface hardened by diffusion of a non-metallic chemical element such as carbon and/or nitrogen. An additional layer of nitride, carbide or oxide of group 4, 5, 6 elements may be deposited on top. EP 1 136 012 A1 describes a construction of a metal watch strap with articulated links designed to reduce wear and tear of the links by avoiding metal-to-metal friction between the hinge pins and the links. Therefore, plastic inserts are introduced in the center links reducing friction and metal-to-metal contact. Document JP 3 058 276 U describes an optimized hinge pin shape for driving in the links of the hinged link strap to increase the holding power (tearing force) by optimizing the profile of the hinge pin ends. Document U.S. Pat. No. 3,837,163 A describes a composite material hinged link watch band comprising a metal matrix with carbide, nitride or hard oxide particles made by powder metallurgy. The aim is to create a visible mirror polished metallic, shiny, scratch and corrosion resistant external surface. Document EP 2 440 085 B1 describes a way of constructing an articulated link strap connection to avoid fracture of hard and brittle materials such as ceramics or sintered hard metals. The solution is an optimized profile of the hinge pin which avoids a pin-link contact in the areas with the highest stresses.

The task of the invention is to provide a further developed assembly device for watch parts, a further developed method for obtaining an assembly device as well as a further developed bracelet and watch, wherein, in particular, effects of wear and/or stretch are reduced without the addition of additional elements.

An assembly device for pivotally attaching at least two parts of a watch serves to solve the task. The assembly device comprises a first part and at least a pin having means to be mechanically connected to a second part. The first part has a first friction surface and the pin has a second friction surface. The first friction surface and the second friction surface contact each other during pivoting movement. According to the invention, one of the friction surfaces has a surface hardness which is higher than the hardness of silica and/or feldspar. The other friction surface has a surface hardness which is lower than the hardness of silica and/or feldspar.

In other words, one of the friction surfaces is “hard” compared to typical abrasive pollutant particles found in watch parts, while the other friction surface is “soft” compared to these particles. Experiments have shown that this configuration surprisingly leads to significantly reduced wear of an assembly device such as in bracelet joints. As a consequence, the stretch and tear of watch bracelets are reduced.

It is generally known that hard or at least surface-hardened materials are basically more resistant to wear. Here, it has been found by the inventors that, surprisingly, the hardening of only one component in the tribological pairing, for example either the pin or the link, is sufficient to drastically reduce the wear of both components of the bracelet joints. For example, the use of hardened pins allows to reduce the wear of the link, even if the latter is not hardened. The wear reduction effect may be achieved by the fact that microparticles of silica and feldspar naturally present in the form of dust are implanted in the soft part of the tribological couple.

In addition, the configuration according to the invention allows the construction of thinner bracelets. Additional elements such as spacers or sleeves on the joint axes or pins are not necessary, while keeping a sufficient thickness of the components for a good mechanical resistance. The fact that no additional elements are required also makes the assembly easier and faster. Another advantage is that at least the component with the lower hardness is comparatively easier to manufacture, machine and assemble. “Component” may refer to one of the two parts of a pivoting assembly which pivot against each other. For example, the first part or link and the pin are components.

For example, the first friction surface has a surface hardness which is higher than the hardness of silica and/or feldspar and the second friction surface has a surface hardness which is lower than the hardness of silica and/or feldspar. Alternatively, the second friction surface has a surface hardness which is higher than the hardness of silica and/or feldspar and the first friction surface has a surface hardness which is lower than the hardness of silica and/or feldspar. The hardness of silica and/or feldspar is typically higher than 500 HV 0.025, for example higher than 600 HV 0.025, and/or lower than 800 HV 0.025, or for example lower than 700 HV 0.025. The hardness of silica and/or feldspar is in typically higher than 5.5 Mohs and/or lower than 6.5 Mohs. The hardness of silica and/or feldspar is in particular higher than 500 Knoop and/or lower than 800 Knoop. The relationship of the surface hardness of the pin and first part or link claimed has to be satisfied using at least one of the above-mentioned hardness measurement methods. In particular, it should be satisfied regardless of the measurement method used.

The surface hardness of the respective friction surfaces is defined in relative terms with respect to the hardness of silica and/or feldspar. The material hardness in regions of the respective part below the first and/or second friction surface (e.g. the bulk or core hardness) may be the same as the surface hardness or different from the surface hardness, for example lower than the surface hardness. For example, surface hardening of the first and/or second friction surface may be performed. In this case, only a defined thickness is hardened so that the respective surface hardness is typically higher than the material hardness below the surface. Principally, the hardness below the surface is irrelevant for the invention, as only the surfaces contact each other. However, to achieve a desired durability, the hardened region should not be too thin, so that the effect according to the invention will not be affected in case of minor surface damage such as scratches.

A pin (also referred to as hinge pin or shaft) is an elongated member which serves for connecting two parts. In particular, a longitudinal or central axis of the pin serves as pivot axis for the pivoting movement of the two parts. In particular, the pin is a solid and/or one-piece member. A pin may be realized as a screw or bolt, for example.

In particular, the assembly device is dedicated for a watch bracelet. In particular, the first part is one of two parts of a watch. In particular, the second part is the other of two parts of a watch. Each of the first and second parts may be one of a bracelet link, a watch case, and a clasp, for example.

The assembly device serves for pivotally attaching at least two parts of a watch. Thus, it serves to rotatably connect the two parts with each other.

The pin is suitable to be mechanically connected to the second part. For example, the pin has, as means for mechanical connection, a contour or shape that fits or corresponds to a contour or shape of the second part, in particular a contour or shape of an opening of the second part. Thus, the pin can be inserted into the opening for mechanical connection. In particular, the mechanical connection is a form-fit and/or force-fit connection in which at least one degree of freedom is restricted.

The first and second friction surfaces are configured for contacting and/or guiding each other during a rotating relative movement. They rub on each other, thus creating friction. Each friction surface serves for pivotally guiding the other friction surface. Each part thus holds or at least contributes to hold the other part during the pivoting movement. For example, radial holding or guiding can be meant. Thus, one part holds the other part such that relative radial movement of the two parts is blocked while relative rotation is possible.

The first friction surface and the second friction surface contact each other at least in points or lines or surfaces. When the two parts are pivoted with respect to each other, the first and second friction surfaces slide on each other and rub against each other at least in points or lines or surfaces.

In one configuration, the assembly device comprises two pins which are arranged coaxially on different longitudinal positions of the same axis. In other words, a pin is separated into two different pins having the same rotational axis. Thus, the first part and the second part are connected by two pins arranged coaxially.

In one embodiment, the pin has means to be fixed to a second part, in particular inside an opening of the second part. In particular, the means to be mechanically connected to a second part are configured as means for to be fixed to a second part, in particular inside an opening of the second part. Said means may comprise a cylindrical or corrugated shape for an interference fit, for example. In particular, the pin has a section with a non-cylindrical cross-section. This allows to easily prevent rotation of the pin about its central axis with respect to the second part. The second part may have a cylindrical or non-cylindrical opening.

In other words, the pin is configured for being immovably fixed to the second part. In particular, the pin is configured for being inserted into an opening, e.g. a through hole or a blind hole, of the second part and for being fixed in this position. The pin may be fixed by interference fit with the opening of the second part. Thus, the pin may have an outer measure, e.g. an outer diameter or width which is slightly larger, e.g. a few micrometers larger, than the corresponding inner measure of the opening. As a result, during driving in, lateral elastic stresses are created in both the end hole and the pin. The strength of the assembly is therefore increased due to these lateral stresses. The pin may have a non-circular cross-section at least at one or both ends. For example, the pin may have a knurled, hexagon or triangle profile.

In one configuration, the pin is driven into the opening. A press is usually used to insert or drive the pin into the opening. Alternatively, the pin may be screwed into the opening.

If a press fit is established, a critical parameter is the interference which is defined as the surface contact between the pin and the opening. The interference approximately depends on the depth of insertion during the assembly and on the difference between the diameter of the opening (hole) and the diameter of the pin. A greater difference will generate a greater holding power at the same insertion depth. However, there are two limits: (1) above a certain stress, the elastic limit will be reached and the material will yield, and (2) the material of the pin may peel while entering the opening. In order to avoid this last phenomenon, the pin material may have a higher hardness than the material forming the opening.

Selection of the materials for the fabrication of the pin and the opening and their associated mechanical properties are often determined by the type of construction and/or the need for mechanical stability of the pin during driving in. The mechanical strength of the pin must be sufficient to prevent it from deforming under the insertion force.

This embodiment serves to ensure a defined pair of friction surfaces. In this way, wear is reduced in an improved manner.

For press-fit assembly, the use of pins with non-circular profiles at their ends, in particular knurled pins, has certain industrial advantages compared to smooth pins. In particular, it allows a better management of the dimensional tolerances of the components and as a consequence the interference.

It is not excluded that, alternatively, the pin may be movably connected to the second part, e.g., pivotally connected. For example, the pin may be movably connected to an opening of the second part. In one configuration, the pin may rotate with respect to the first and second parts.

In one embodiment, the first part comprises an opening with an inner circumferential surface providing the first friction surface. In one embodiment, the pin comprises an outer circumferential surface providing the second friction surface.

The first part may have an opening in which the pin may be arranged. The opening may have a circular cross-section at least in parts. In particular, the opening has a circular cross-section. The pin may have a circular cross-section at least in parts. In particular, the pin has a circular cross-section. At least a section of the outer circumferential surface of the pin may serve as the second friction surface. At least a section of an inner circumferential surface of an opening of the first part may serve as the first friction surface. Thus, the first part and the pin may cooperate to form a hinge.

In particular, the second friction surface is provided on a contact portion of the pin. The contact portion may be an axial portion of the pin. Thus, an axial portion of the pin is configured for contacting the first friction surface. In particular, in this configuration, the opening of the first part and the opening of the second part are aligned to form a passageway for receiving the pin.

In a particular embodiment, the pin comprises a screw head on a first end portion and a threaded section on a second end portion. In particular, the threaded end serves as a means for firm mechanical connection to the second part.

The second end portion is opposite of the first end portion. In particular, each end portion is an axial end portion. In this embodiment, the pin is configured as a screw which can be screwed into the second part. In particular, the pin further comprises a central portion arranged axially between the two end portions.

In one embodiment, the pin comprises a central portion, a first end portion and a second end portion. The first end portion and the second end portion are designed to be mechanically connected, in particular fixed, to the second part.

The end portions and the central portion are different portions along the axial direction of the pin. In this embodiment, the pin is connected to the second part on both sides. Thus, the mechanical connection is particularly stable and durable. Bending loads on the pin are minimized. Thus, wear is reduced in a further improved manner.

In a further embodiment, the first part is configured as a sleeve arranged around at least a section of the pin.

In this embodiment, the pivoting movement takes place between the pin and the sleeve. In particular, the sleeve is fixed to the second part, e.g., by press fit. The second part may form a link of the bracelet. The first part may be configured such that it is not or barely visible in the finished bracelet. The sleeve may be fixed on the pin against axial movement. Thus, the sleeve cannot be removed from the pin.

In this embodiment, the surface areas of the first and second friction surfaces are maximized. Thus, minimum frictional forces occur, and wear is reduced in a further improved manner.

In particular, the opening of the sleeve has a circular cross-section. Thus, it surrounds the pin circumferentially. In particular, the inner diameter of the sleeve is slightly greater than or substantially the same as the outer diameter of the pin. Thus, the surface areas of the friction surfaces are further increased while, at the same time, ensuring good pivoting mobility. The outer shape of the sleeve can be selected in dependence on the second part or the opening therein and the mechanical connection or fixation to the second part. In one configuration, the sleeve has an annular cross-section.

In one embodiment, the first part is a bracelet link and/or the second part is a bracelet link. A bracelet link is one of a plurality of parts of which a bracelet is composed. In one embodiment, the assembly device serves for pivotally attaching two bracelet links to each other.

The first and second parts may be similar or identical. The first and second parts may be individual links of the bracelet, in particular adjacent links. Alternatively, the first and second parts may be different in design. For example, different parts may be used in an alternating manner for forming the bracelet. One of the first and second parts may be a bracelet link and the other one of the first and second parts may be a linking element which may be at least partly visible or invisible in the mounted bracelet.

In one configuration, the pin is provided separately from each of the parts. Thus, for example, two parts are attached to each other by means of the pin. In an alternative configuration, the pin is part of the second part. Thus, the second part is attached to the first part using the pin of the second part. The pin may be attached to the rest of the second part by a form-fit (positive) connection, a force-fit (frictional/non-positive) connection and/or by integral bonding, such as laser welding for example. The pin may be made integral with the rest of the second part.

In one embodiment, the first part or the second part is a watch case. A watch case is a container in which a watch movement is accommodated. A watch case protects the watch movement from dust, humidity and shocks. In one embodiment, the assembly device serves for pivotally attaching a bracelet link to a watch case. For example, one of the first and second parts may be a bracelet link and the other one of the first and second parts may be a watch case. In this case, the assembly device forms the joint between the watch case and the bracelet.

In one embodiment, the first part or the second part is a bracelet clasp. A bracelet clasp serves to open and close (fasten) the bracelet. In one embodiment, the assembly device serves for pivotally attaching a bracelet link to a clasp. For example, one of the first and second parts may be a bracelet link and the other one of the first and second parts may be a clasp. In this case, the assembly device forms the joint between the clasp and the bracelet.

In one embodiment, the assembly device further comprises the second part.

In one embodiment, the one of the friction surfaces having a surface hardness higher than silica and/or feldspar has a surface hardness of at least 800 HV 0.025, preferably at least 900 HV0.025, even more preferably at least 1000 HV 0.025. The hard part of the joint thus has a surface hardness which is higher than the hardness of silica and feldspar microparticles. In this way, the abrasive microparticles settle in the soft part and form a protective layer, thus limiting its wear. Since the surface of the hard part is harder than the abrasive microparticles, it does not wear or wears only very little.

In particular, the one of the friction surfaces having a surface hardness higher than silica and/or feldspar has a surface hardness of at most 3100 HV 0.025, in particular at most 1.500 HV 0.025. All hardness values refer to HV 0.025, unless otherwise indicated.

In one embodiment, the other one of the friction surfaces, having a surface hardness lower than that of silica and/or feldspar, has a surface hardness of at most 500 HV 0.025, preferably at most 350 HV 0.025, even more preferably at most 320 HV 0.025 or 300 HV 0.025 and/or at least 120 HV 0.025, preferably at least 250 HV 0.025. In this way, it allows the implantation of abrasive microparticles of silica and feldspar with a hardness in the range of 500 to 800 HV0.025.

Microparticles are understood to be particles having a small particle size of approx. 0.1 to 100 μm. Analysis of soiling material extracted from several bracelet watches worn for a long time shows that the particles typically have d₅₀=30±10 μm. The particle size is determined by laser diffraction method according to ISO 13320:2020. The particles observed with SEM have rather angular shapes.

In one embodiment, the second friction surface of the pin has the surface hardness which is higher than the hardness of silica and/or feldspar. The higher surface hardness of the pin leads to better mechanical properties of the pin in respect to the first and/or the second parts of an assembly device. The pin which is the component subjected to the highest loads is thus the harder of the two materials. In this case it is easier to assemble by press fit. It is also often easier to manufacture a pin compared to more complex shaped the first and/or the second parts.

Alternatively, the first friction surface of the first part has the surface hardness which is higher than the hardness of silica and/or feldspar.

According to the invention, the combination of materials forming the assembly is selected with primary consideration of the surface hardness of the materials relative to the hardness of silica and feldspar, as described. Among the materials satisfying these hardness properties, the person skilled in the art will be able to freely choose the nature of the materials (e.g., metal and/or composite) according to known manufacturing and/or functional criteria (such as shaping, machining, toughness, strength, assembly methods, for example). In one configuration, the material forming the first friction surface and/or the material forming the second friction surface is surface hardened.

In one embodiment, a material forming the one of the friction surfaces having a hardness higher than that of silica and/or feldspar (material whose surface hardness is higher than silica or feldspar) is surface-hardened metal or metal alloy, preferably surface-hardened titanium or titanium alloy, or surface-hardened steel, preferably surface-hardened austenitic steel. The material whose surface hardness is higher than silica or feldspar may be a metal or a metal alloy. This material can be through-hardened or surface-hardened. The preferred surface methods of hardening are thermal diffusion, ion implantation and oxidation heat treatments. Preferably, materials with a surface hardness between 800 and 1500 HV0.025 are chosen. Examples of such materials are metallic glasses (nickel, iron, cobalt or niobium based), surface-hardened titanium alloys, high entropy alloys, metal matrix composites (MMC), surface-hardened stainless steels, surface-hardened nickel free stainless steels, surface-hardened group 4 alloys.

The material whose surface hardness is higher than silica or feldspar may be or comprise at least one material chosen from the group of stabilized ceramics; metallic glasses; high entropy alloys; metal matrix composites; surface hardened stainless steels; surface hardened titanium and titanium alloys; surface hardened metal alloys of group 4. Preferably, the material may be chosen from the group of metallic glasses based on nickel, iron, cobalt and niobium; surface hardened high-nitrogen austenitic stainless steels of type P558, P2000 and Biodur® (an essentially Nickel- and Cobalt-free high-strength stainless steel produced with the electro-slag remelting process which is non-magnetic and essentially free of ferrite phase, with the following constituents: C (maximum): 0.08%, P (max) 0.03%, Si (max) 0.75%, Ni (nominal) 0.1%, Mn (max) 21.00-24.00%, S (max) 0.01%, Cr (nom) 19.00-23.00%, Co (nom) 0.1%, Mo (nom) 0.50-1.50%, Cu (nom) 0.25%, N (nom) 0.9% and Fe (nom) in balance); surface hardened austenitic steels of type 316L and 904L; surface hardened Titanium Grade 2 alloys, Titanium Grade 5 alloys, Titanium Near Beta alloys, Titanium Beta alloys; surface hardened binary and ternary alloys of group 4 metals. More preferably, the material may be chosen from the group of surface hardened austenitic stainless steels of type 316L and 904L; surface hardened Titanium Grade 2 and Titanium Grade 5 alloys by thermal diffusion of oxygen or by thermal nitriding and diffusion of nitrogen; surface hardened binary and ternary alloys of Ti, Zr, Hf by thermal oxidation treatment. Suitable methods of surface hardening of titanium and titanium alloys by thermal nitriding and nitrogen diffusion is disclosed in WO 2017 202 728 A1. Suitable methods of surface hardening of titanium and titanium alloys by thermal oxygen diffusion is disclosed in WO 2017 207 794 A1. Suitable methods of surface hardening of iron alloys by thermal carbon and/or nitrogen diffusion is disclosed WO 2011 009 463 A1. Suitable ternary alloys and methods of their thermochemical surface hardening are disclosed in co-pending patent application EP23171553.3.

Hardening only the surface and not the complete component is sufficient, because the important parameter is the surface hardness. Thus, it is not necessary to harden the whole component (through-hardening). This can save energy and cost.

In addition, hardening or surface-hardening allows the use of the same materials for the two components of the assembly, e.g., for the pin and the link, or materials in the same class, suitable for mass and/or surface hardening, with similar colors. In this way, galvanic corrosion in a polluted environment is reduced, because the electrochemical potential between the joint elements remains low. Another advantage is that, when the pins are visible, the aesthetics of the external surfaces of the bracelet are preserved. Moreover, a through- or surface-hardened pin can be mounted by driving the pin into a link of the non-surface-hardened material, which is difficult, if not impossible, in the case where the pin is in the same metallurgical state as the link. In addition, hardening or surface-hardening allows to manufacture bracelets with driving-in pins in which all parts are made of titanium or titanium alloy, taking advantage of the low density and hypoallergenic properties of the material.

In one configuration, the pin is hardened by surface-hardening, in particular by at least one thermochemical treatment. For example, a nitriding, carburizing and/or nitrocarburizing treatment can be used for stainless steels and/or diffusion of at least one element selected from oxygen, nitrogen and carbon for titanium alloys. The surface hardening of the pin reduces the wear of the pin and the opening or hole of the first and/or second part and allows the driving of knurled pins into parts with a hardness similar to the core hardness of the pin.

In particular, the thermochemical treatment may be carried out for steel or ferrous metals according to the method disclosed in WO 2011/009463 A1, the contents of which is incorporated herein by reference. Said method comprises activating an article of passive ferrous or non-ferrous metal, which activation comprises heating the article to a first temperature, heating at least one compound containing nitrogen and carbon, hereinafter called N/C-compound, to a second temperature for providing one or more gaseous species, and contacting the article with the gaseous species, wherein the N/C-compound comprises at least four atoms. Preferably, the method is used to activate an article prior to subsequent case hardening by carburising, nitriding or nitrocarburising. Generally, the N/C-compounds used in the activation method may be selected among compounds having a single, double or triple carbon-nitrogen bond. Preferably, the N/C-compound is a liquid or a solid at temperature (25° C.) and atmospheric pressure (1 bar). This facilitates the handling of the N/C-compound and its possible introduction into a heating apparatus used in the method. The gaseous species evolving from the N/C-compound upon heating may be decompositions products of the same, or the N/C-compound as such in gaseous form. The gaseous species are transported to the article, usually by diffusive and/or convective gas transport, and are contacted with the same. Preferably, the first and the second temperatures are below 500° C. In this way formation of nitrides or carbides can be prevented. This is particularly relevant for stainless steel and similar alloys where the corrosion resistance may be lost if nitrides or carbides are formed. The first and the second temperature may be the same. For example, an article of austenitic stainless steel AISI 316 can be nitrocarburised in a tube furnace by leading argon gas over, initially solid, urea while heating from room temperature to 440° C. within 45 minutes. The initially solid urea is positioned at the inlet of the tube furnace. Upon reaching 440° C. the article is cooled to room temperature in argon gas (Ar) within 10 minutes. The total thickness of the hardened zone (region) is about 10 μm. As another example, an article of austenitic stainless steel AISI 316 can be nitrocarburised in a tube furnace by leading hydrogen gas over initially solid urea while heating from room temperature to 490° C. within 45 minutes. The initially solid urea is positioned at the inlet of the tube furnace. Upon reaching 490° C. the article is cooled to room temperature in argon gas (Ar) within 10 minutes. The total thickness of the hardened zone is about 22 μm. The micro-hardness of the surface is more than 1500 HV (as measured with a load of 25 g). The untreated stainless steel had a hardness between 200 and 300 HV.

For surface-hardening of titanium, the method disclosed in WO 2017/207794 A1 can be employed, for example. The content of this document is incorporated herein by reference. This method comprises the steps of:
providing a component of a titanium alloy,
placing the component in a reactive atmosphere comprising a carbon providing gaseous species at a partial pressure of at least 10-5 bar, the carbon providing gaseous species containing carbon and oxygen, and which reactive atmosphere does not comprise a hydrogen containing species,
heating the component in an inert atmosphere or the reactive atmosphere to a dissolution temperature TD of at least 800° C.,
maintaining the component in the reactive atmosphere at TD for a reactive duration of at least 30 min to provide the component with a diffusion zone comprising carbon and oxygen in solid solution and having a distinct phase of a carbo-oxide compound having the composition TiOₓC₁₋ₓ, wherein x is a number in the range of 0.01 to 0.99,
cooling the component from TD to ambient temperature.

The component is of a titanium alloy, and any titanium alloy, including pure titanium, may be employed. The component may be of a group 4 metal, and any group 4 metal is appropriate for the method. The group 4 metal may be selected from the list of titanium, titanium alloys, zirconium and zirconium alloys. The component may consist of the titanium alloy, or a group 4 metal, or it may comprise other materials. For example, the component may have a core of another material, a polymer, glass, ceramic or another metal, and an outer layer of the titanium alloy.

For example, a grade 5 titanium sample is treated in a furnace. The furnace is evacuated and backfilled with argon gas twice and a continuous gas flow consisting of 20 ml/min Ar and 30 ml/min CO (60% CO) is applied. The sample is heated to 1000° C. at a rate of 20° C./min in the same gas mixture and upon reaching the temperature held there for 20 hours. Cooling is carried out at 50° C./min in the flowing process gas. This results in carbo-oxidation of the titanium. A mixed interstitial compound TiOₓC₁₋ₓ and a mixed interstitial solid solution based on carbon and oxygen (‘diffusion zone’) are formed. The hardness of the TiOₓC₁₋ₓ is 1416 HV0.025. The case depth is approximately 80 μm. The core has transformed into an α/β structure, i.e. simultaneous core and surface hardening took place.

Alternatively, a grade 2 titanium sample is treated in a furnace. The furnace is evacuated and backfilled with argon gas twice and a continuous gas flow consisting of 10 ml/min Ar, 30 ml/min CO₂ and 20 ml/min CO is applied (p_{co}=0.33 atm and p_{CO2}=0.50 atm). The sample is heated to 1000° C. at a rate of 20° C./min in the same gas mixture and upon reaching the temperature held there for 20 hours. Cooling is carried out at 50° C./min in the flowing process gas. The applied gas results in oxidation of the titanium. A layer of titanium oxide is formed having a thickness of about 25 μm and a diffusion layer of oxygen in solid solution in titanium is formed (below the oxide layer)—the diffusion layer has a thickness of about 100 μm.

For nitridation of titanium, the method of WO 2017/202728 A1, which is incorporated herein by reference, may be used. This method comprises the steps of
a) heating the workpiece to an initial nitriding temperature and;
b) subjecting said workpiece to one or more nitriding temperatures for predetermined time(s) in a nitrogen containing gas under high pressure at Hot Isostatic Pressing (HIP) conditions for converting the titanium metal surface layer to a first layer portion consisting of ceramic titanium nitrides and a second layer portion comprising a nitrogen gradient in the titanium metal, and
c) quenching the workpiece in the nitrogen containing gas under high pressure at Hot Isostatic Pressing (HIP) conditions as a first step in a hardening heat treatment, in order to further strengthen the titanium metal below the first ceramic nitride layer portion formed in step b).

Work pieces comprising commercially pure titanium (Grade 2) in the form of thin-walled tubes (t=1.0 mm) are placed in a hot isostatic press. Nitrogen gas, N₂ is supplied to the chamber of the press. During step a) the temperature of the gas is increased until the temperature of the workpiece reaches 960° C. Simultaneously, the pressure of the gas is increased to 170 MPa. In step b) the same temperature and gas pressure is maintained for 2 hours. Since this temperature is already above the “β transus” temperature, an increase in temperature in step b) is not needed for this titanium alloy. In step c), the workpiece is quenched by cooling nitrogen gas according to the following cooling rates of the gas:
600 K/min between 960-900° C.,
2460 K/min between 900-800° C.,
1440 K/min between 800-700° C.,
1020 K/min between 700-600° C. and
600 K/min between 600-500° C.

The temperature of the gas is measured by thermocouples. In this case, no aging treatment is carried out. In step e) the work pieces are cooled to room temperature. All of the steps a), b) and c) are carried out in the hot isostatic press under nitrogen gas at pressures up to 170 MPa.

In a one embodiment, surface-hardening may be performed by thermal diffusion of at least one non-metallic element, preferably selected from the group of oxygen, carbon and nitrogen for titanium and titanium alloys and from the group of nitrogen and carbon for austenitic stainless steels. The heat treatment typically takes place at an elevated temperature and under a controlled atmosphere comprising oxygen, nitrogen and/or gases comprising carbon, nitrogen and oxygen, for example as described in patent applications WO 2017 207 794 A1 for titanium and titanium alloys and in WO 2011 009 463 A1 for austenitic stainless steels.

An alternative heat treatment can be performed by ion implantation under low to moderate vacuum, for example as described in patent application WO 2010 063 928 A1. In a vacuum chamber, the ion source, for example an electron cyclotron resonance (ECR), produces an ion beam of desired chemical elements which, when ionized, bombard the target part, implant themselves in its surface and, as a result, heat it at the same time, thereby facilitating their diffusion.

The hardened layer may be such that it has a hardness greater than 800HV over a depth of at least 5 μm, preferably 10 μm, with a favorable window between 10 and 80 μm. Finishing operations such as polishing, sandblasting, or brushing can be performed after the surface hardening, thus requiring sufficient layer thickness.

In one embodiment, a material forming the other one of the friction surfaces having a hardness lower than that of silica and/or feldspar (material with a surface hardness lower than that of silica and/or feldspar) is unhardened or at least surface-unhardened metal or metal alloy, preferably unhardened or at least surface-unhardened titanium or titanium alloy, or unhardened or at least surface-unhardened steel, preferably unhardened or at least surface-unhardened austenitic steel, or a metal matrix composite material, or a precious metal alloy comprising Au, Ag, Pd or Pt.

Unhardened means that a material has not been hardened intentionally. Surface-unhardened means that the material has not been surface-hardened intentionally. In particular, the material has not been hardened at all (unhardened). Thus, wear reduction is achieved while keeping the manufacturing effort low. Through-hardened means that a component has been hardened such that the hardness is increased throughout the whole component. In particular, the resulting hardness is essentially constant throughout the component.

The material with a surface hardness that is lower than that of silica and/or feldspar may be a metal or metal alloy. It can be through-hardened, for example by quenching or precipitation, or surface-hardened. The preferred surface hardenings are thermal diffusion treatment, ion implantation and thermal oxidation treatment. However, the surface hardness does not exceed that of silica and feldspar. Preferably, materials with a surface hardness between 120 and 500 HV0.025 are chosen. Among these materials, examples are stainless steel, 904L stainless steel, nickel-free stainless steel, titanium and titanium alloys, preferably Beta Titanium alloys, Near Beta Titanium alloys, Grade 2 and Grade 5 Titanium alloys, metal matrix composites, aluminum alloys including TiAl, metallic glasses (zirconium, titanium, copper, platinum or palladium based), precious metal alloys (gold, platinum, palladium-based alloys), magnesium alloys, alloys from group 4 of the periodic table. The material may be or comprise at least one material chosen from the group of a metal matrix composites (MMC); metallic glasses; precious metal alloys; magnesium alloys; aluminium alloys; copper alloys; binary and ternary alloys of group IVB. Preferably, this material is chosen from the group of metallic glasses based on zirconium, titanium, palladium and copper; austenitic stainless steels; nickel-free austenitic stainless steels; titanium alloys of Titanium Beta, Titanium Near Beta, Titanium Grade 2 and Titanium Grade 5 types; aluminium alloys; copper alloys of CuAl type; precious metal alloys of silver, gold, platinum and palladium; binary and ternary alloys of group 4 metals such as titanium, zirconium and hafnium. More preferably, this material may be chosen from the group of high nitrogen austenitic stainless steels of P558, P2000, Biodur®; austenitic stainless steels of 316L and 904L types; aluminium alloys of TiAl type; titanium alloys of Titanium Beta, Titanium Near Beta, Titanium Grade 2 and Titanium Grade 5 types; precious metal alloys of silver, gold, platinum and palladium; binary and ternary alloys of titanium, zirconium and hafnium.

In case of a bracelet whose links are made of metal or a metal alloy, the articulation pins are in particular made of the same metal or alloy as the links, but in a different material state as regards surface hardness. For example, links made of Grade 5 Titanium and pins made of surface-hardened Grade 5 Titanium are chosen.

These non-through hardened materials can be combined with a surface-hardened titanium alloy or stainless-steel pins. The invention thus makes it possible to manufacture bracelets in which all the parts are made of titanium or a titanium alloy with surface-hardened links or pins, in order to take advantage of the low density of the material, without suffering from the titanium-titanium friction known in the prior art for its high wear by adhesion.

In one configuration, the pin and the first part and/or the pin and the second part are made of the same material. Subsequent treatment such as hardening may lead to the different surface hardness. For example, both parts may be made of titanium, a titanium alloy or austenitic steel.

A further aspect of the invention is a method for obtaining an assembly device, in particular according to the invention. The method comprises a treatment of a friction surface selected from thermal treatment, thermochemical treatment, ion implantation treatment and mechanical cold working. In particular, only the surface is treated to achieve hardening such that the bulk material below the surface is not hardened or hardened to a lesser extent. All features, embodiments and advantages of the assembly device described at the beginning may also apply to the method and vice versa.

In particular, the friction surface having the surface hardness higher than the hardness of silica and/or feldspar is treated as described.

In one embodiment, the treatment is selected from nitriding, carburizing or nitrocarburizing heat treatment for surface hardening of steel, and/or a heat treatment with at least one element selected from oxygen, nitrogen and carbon for surface hardening of titanium alloy.

A further aspect of the invention is a bracelet, comprising at least one assembly device according to the invention. The bracelet is in particular a watch bracelet.

A further aspect of the invention is a watch, comprising a bracelet having at least one assembly device according to the invention. In one embodiment, the watch comprises a bracelet and the assembly device is a part of the bracelet. All features, embodiments and advantages of the assembly device and the method described above may also apply to the bracelet and the watch and vice versa.

In the following, exemplary implementations of the invention are explained in more detail using figures. Features of the exemplary implementations can be combined individually or in a plurality with the claimed objects, unless otherwise indicated. The claimed scopes of protection are not limited to the exemplary implementation.

The figures show:

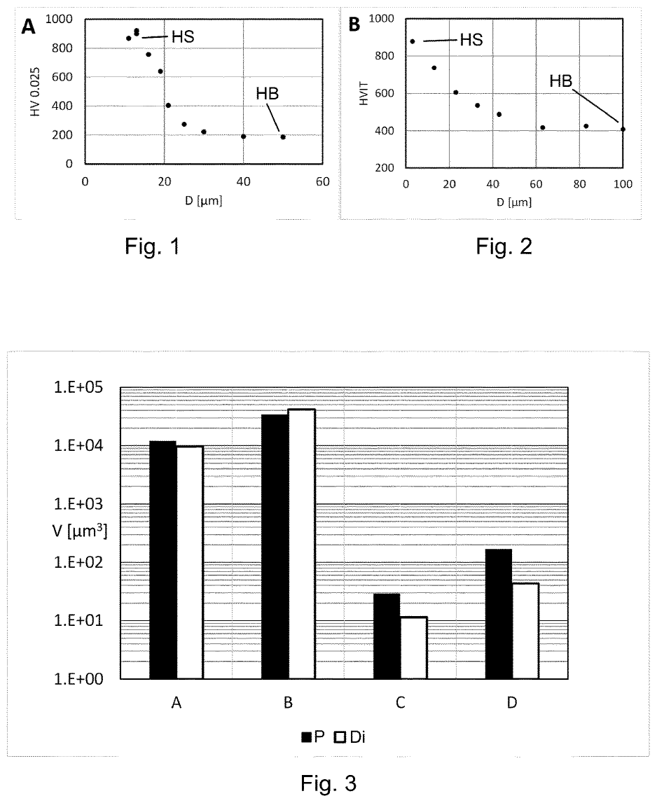

FIG. 1: a hardness profile of a sample;

FIG. 2: a hardness profile of another sample;

FIG. 3: a graph comparing wear volumes;

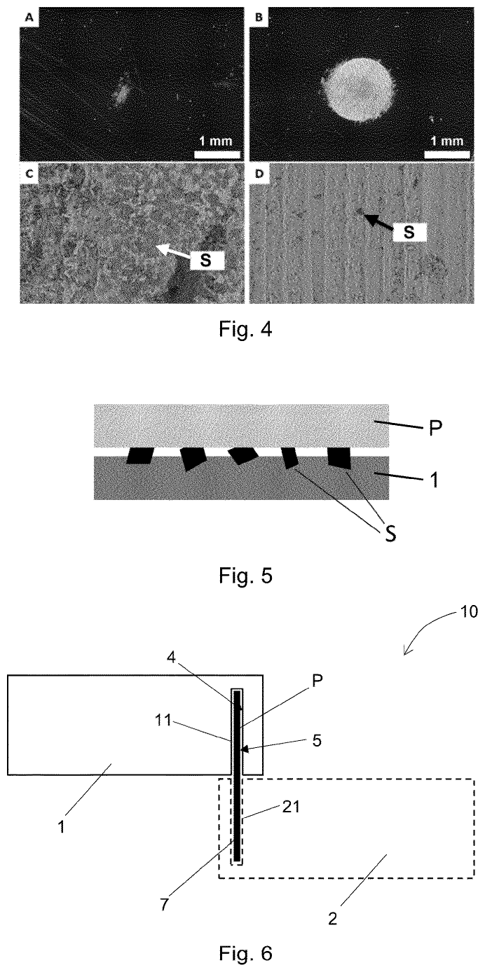

FIG. 4: optical microscope images of disks subjected to wear;

FIG. 5: a schematic drawing of a protection effect;

FIG. 6: an assembly device according to the invention;

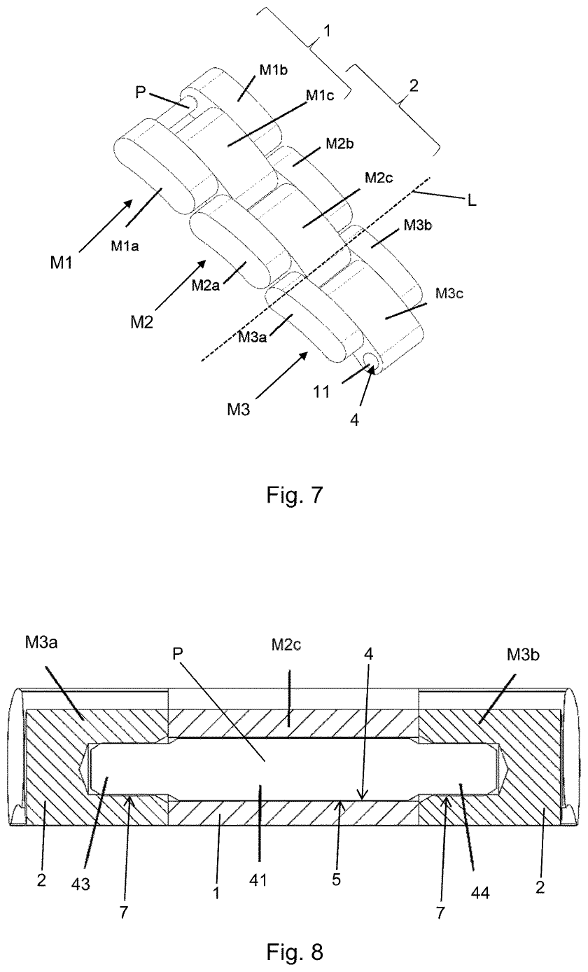

FIG. 7: a part of a watch bracelet according to the invention;

FIG. 8: a section through a rotatable attachment according to the invention;

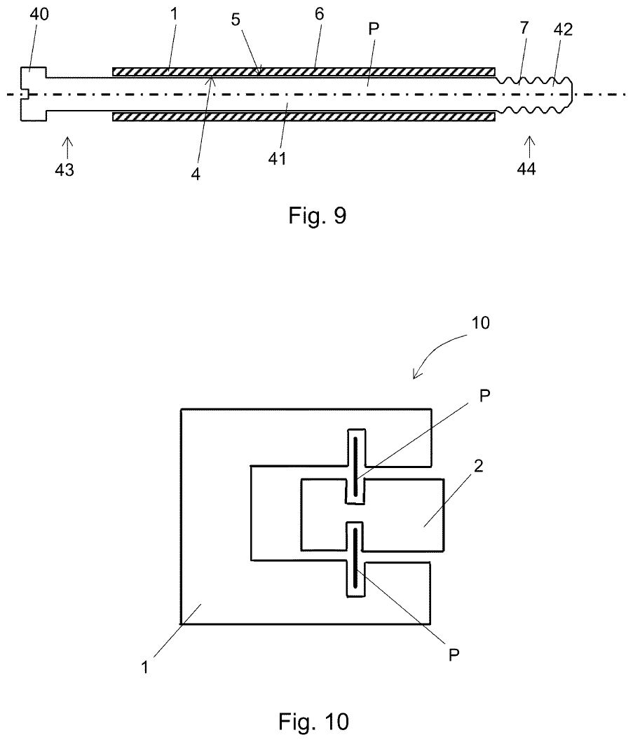

FIG. 9: a pin of an assembly device according to the invention; and

FIG. 10: a further assembly device according to the invention.

### EXPERIMENTS

Experiments were performed using the materials presented in the Table 1.

TABLE 1
surface hardness according to Vickers HV0.025 of materials used

| | Material | | | | | |
|---|---|---|---|---|---|---|
| | Cobalt | | | | | |
| | superalloy | | | | | |
| | Nivaflex | | | | | Silica |
| | 45/18 | Steel 904L | | Grade 5 Titanium | | microparticles |
| | Material condition | | | | | |
| | | Surface | Surface- | Surface | Surface- | |
| | Hardened | unhardened | hardened | unhardened | hardened | |
| Surface hardness [HV 0.025] | 350 to 500 | 150 to 250 | ≥1′000 | 250 to 350 | ≥900 | 500 to 800 |

Steel 904 L is a corrosion resistant superaustenitic steel having high amounts of Ni and Cr as well as Mo and Cu according to the standard AISI 904L (1.4539). The formula is X1NiCrMoCu25-20-5. Other designations are SS2562 (Sweden), UNS N08904 (USA), AFNOR Z2NCDU25-20 (France). Nivaflex 45/18® is a nonmagnetic Co—Ni—Cr alloy. It comprises 42 to 48% Co, 15 to 25% Ni, 16 to 22% Cr and each 2 to 6% Mo, W and Fe and traces of Ti, Mn and Si. The amount of C is below 0.15 wt %. Grade 5 titanium is a titanium alloy according to ASTM B348 which contains 6 wt % of Al and 4 wt % of V. Silica microparticles are commercial grade of silica particles (SiO₂) with d₅₀=30 μm and d₉₀=62 μm. Particle size distribution is determined by the laser diffraction method according to ISO 13320:2020. They can be obtained from Sibelco under product name Sibelco Sepasil B 5/63.

By annealing, a component is subjected to heat treatment throughout the complete body, i.e., the resulting hardness is the same throughout the component. Typically, hardness is reduced through annealing. Thus, the hardness is lower than in hardened or surface-hardened components of the same material.

### Experiment 1

FIG. 1 shows a hardness profile of a surface-hardened control sample made of 904L steel according to a Vickers hardness test. FIG. 2 shows a hardness profile of a surface-hardened control sample made of surface-hardened Titanium Grade 5 according to a Vickers hardness test 5. The Grade 5 Titanium components have been surface hardened by thermal diffusion of oxygen under a controlled atmosphere. The 904L steel components have been surface hardened by thermal diffusion of carbon under a controlled atmosphere of a carbon-containing gas mixture.

In both cases, the horizontal axes show the depth D in μm measured from the surface of the respective control sample. Therefore, HS designates a respective hardness value close to the surface and HB designates a bulk hardness in an inner part of the control sample. The vertical axes show the respective hardness. In FIG. 1, the hardness shown is Vickers hardness HV0.025 which was measured on a hardness tester according to ISO 6507-1, 2^{nd} ed. 1997, with 0.025 being the load in kgf (kilogram force). In FIG. 2, the hardness shown is instrumented Vickers hardness HVIT, measured by nano-indentation according to ISO 14577-1, 1^{st} ed. 2002, Metallic materials-Instrumented indentation test for hardness and materials parameters—Part 1: Test method.

The hardness profile for 904L steel was measured on a microdurometer (according to the above-cited ISO 6507-1, 2^{nd} ed. 1997) with a load of 0.025 kgf. For surface-hardened Grade 5 Titanium, the hardness profile was measured by nanoindentation according to ISO 14577. The thickness measurement of the hardened layer can be done using a metallographic section on which the layer is visible under an optical microscope. On the other hand, the parallel measurement of a hardness profile may be necessary to determine the correspondence between the depth at which the hardened layer can be distinguished by the optical contrast and the hardness at this depth according to the profile.

It can be seen in the figures that there is a hardness gradient from surface to bulk. The hardness is greater on and close to the surface, while the hardness is lower in the bulk. The influence of the surface hardening extends between approx. 30 μm for steel and approx. 50 μm for Titanium. Beyond this depth, the hardness is the same as in untreated material.

The thickness of a hardened layer may be defined as the depth at which its hardness reaches a certain value greater than the core hardness of the sample. According to this definition, for example, the thickness of the surface-hardened layer for the Grade 5 Titanium is between 8 μm and 12 μm for the hardness of 800 HV. For the hardened 904L steel it is between 15 μm and 18 μm for the same hardness.

### Experiment 2

This experiment relates to tribometric properties of the materials used. A tribometer is an instrument that allows two materials to rub against each other in a controlled manner. The tribometer used can also be referred to as pin-on-disk tribometer. The tribometer has an arm to which is attached a hemispherical-headed pin, made of one of the materials to be tested, which presses with a determined force against a disk, made of the second material. The disk is driven in linear movement under the pin with the amplitude adjusted to simulate the motion while wearing a watch with a bracelet. In the tests carried out, the worn volumes are measured using a confocal microscope. The confocal microscope allows to precisely map the topography of the worn trace on the pin and the disk, respectively. The worn volume is then determined by measuring the volume of material that has been removed during the test, creating the worn trace.

The surface hardened pins made of 904L steel and Titanium Grade 5 were prepared as the control samples in the Experiment 1.

FIG. 3 shows the results of the polluted-condition tests on a tribometer. These tests attempt to reproduce the real conditions in which a watch bracelet is worn. They were carried out under ambient air with an additive called “synthetic pollutant”. The latter is composed of an abrasive, formed of silica powder, and organic oil, as described in EP 2 057 914 A1.

The wear volumes of the pin P (black) and disk Di (white) averaged over two tests are shown in logarithmic scale on the vertical axis in cubic micrometers. The pairs of materials tested are indicated on the horizontal axis as A, B, C and D. The material of the pin is mentioned first, followed by the material of the disk (pin/disk). A is Nivaflex cobalt alloy surface unhardened/904L steel surface unhardened; B is Titanium Grade 5 surface unhardened/Titanium Grade 5 surface unhardened; C is Titanium Grade 5 surface hardened/Titanium Grade 5 surface unhardened; and D is 904L steel surface hardened/904L steel surface unhardened.

A corresponds to the prior art and is shown as a reference example. It shows the wear of the pin and the disk by friction between a disk made of surface unhardened 904L steel and a pin made of Nivaflex-type cobalt superalloy, which is the standard material condition in the field of watch bracelets. The 904L steel component has a hardness in the range of 150 to 250 HV0.025 and the Nivaflex component has a hardness in the range of 350 to 500 HV0.025.

B is another reference example and shows the wear of the pin and the disk by friction between a Grade 5 Titanium surface unhardened disk and a Grade 5 Titanium surface unhardened pin. Both components of the tribological pair have a hardness in the range 250 to 350 HV0.025.

C is an example according to the invention and shows the wear of the pin and the disk by friction between a surface unhardened Grade 5 Titanium disk and a Grade 5 Titanium pin surface-hardened by thermal diffusion of oxygen atoms. The disk has a hardness in the range of 250 to 350 HV0.025 and the pin has a surface hardness higher than 900 HV0.025.

D is a further example according to the invention and shows the wear of the pin and the disk by friction between a disk made of surface unhardened 904L steel and a pin made of 904L steel surface-hardened by thermal diffusion of carbon atoms. The disk has a hardness in the range of 150 to 300 HV0.025 and the pin has a surface hardness higher than 900 HV0.025.

The surprising wear reduction effect in the tribological pairs according to the invention with surface-hardened pins, shown in C and D, is significant. The difference compared to the references, Nivaflex/904L and Titanium Grade 5 surface unhardened/Titanium Grade 5 surface unhardened as shown in A and B in FIG. 3, reaches almost two orders of magnitude. In particular, there is a decrease in wear of the “soft” disks (904L surface unhardened and Titanium Grade 5 surface unhardened) when they are rubbed against surface-hardened materials in the presence of a synthetic pollutant.

FIG. 4 shows microscope images of disks subjected to wear. In order to better understand the decrease in wear of the soft component (surface unhardened 904L disc and surface unhardened Grade 5 Titanium) when it is rubbed against a surface-hardened component, additional analyses were performed. The images in FIG. 4 show the wear pattern of a surface unhardened Grade 5 Titanium disc rubbed against a surface-hardened Grade 5 Titanium pin (FIGS. 4A and 4C; according to the invention) and against a surface unhardened pin (FIGS. 4B and 4D; comparative Example). They offer another illustration of the difference in the worn volume generated when the same disc in the surface unhardened state is rubbed against a surface-hardened pin or a surface unhardened pin. It is clearly visible that the wear of the disc is greater (larger wear spot) when the pin is not surface-hardened.

Scanning electron microscopy analysis of worn surfaces, shown in FIG. 4C and FIG. 4D, sheds light on the reasons for the low wear observed on the discs from the tests with surface-hardened pins compared to the tests with surface unhardened pins. At the bottom images 4C and 4D, the label S indicates silica microparticles incorporated into the softer, surface-unhardened discs. It is clearly visible that in the case of a surface-hardened pin, there is a much larger amount of silica microparticles incorporated into the softer counterpart, the disc, as compared to the case with the surface unhardened pin.

Comparing these two figures, it is clear that the silica contained in the synthetic pollutant behaves differently in each case. When both components are in the surface unhardened state (FIGS. 4B and 4D; comparative Examples), the silica manages to embed itself on both the disc and the pin, because these two parts have lower hardness than the silica contained in the abrasive (250 to 350HV0.025 for the disc and the surface unhardened Grade 5 Titanium pin against a hardness of 500 to 800 HV for the silica powder). Each time the pin passes over the disc, material is torn off on both sides, causing significant wear.

On the other hand, when the pin is surface hardened (FIGS. 4A and 4C; according to the invention), the abrasive particles stick into the disc, but do not manage to embed themselves in the pin, whose surface hardness is higher than 900HV0.025. Due to its higher hardness, the pin will cut (by abrasion) the silica embedded in the disc, without being damaged. The inventors also note that there is no “plowing” of the disk as observed in the tests with a surface unhardened pin (FIG. 4D; comparative Example). In the configuration according to the invention, the presence of the silica seems to protect the disk from wear.

Tribometer tests indicate that the surface-hardening of one of the two components (e.g., pin) protects the softer component (e.g. disc or link), with the silica acting as an interface between the two components.

FIG. 5 schematically illustrates the protection effect of silica microparticles on the wear of an articulated link (rotatable attachment). P denotes a pin, 1 denotes a first part, for example a bracelet link, S denotes silica microparticles. The silica microparticles S incorporate into the softer link body 1 and protect it from abrasive wear by microparticles.

The presence of the silica at the interface between the pin and the link limits the contacts, thus minimizing or cancelling the wear of the link. The pin being harder than the silica, it is not or only slightly damaged and seems to rather “polish” the silica. This mechanism is possible by virtue of the greater hardness of one of the two components compared to the abrasive.

### Experiment 3

A surface unhardened Grade 5 Titanium pin driven into an opening (hole) in a surface unhardened Grade 5 Titanium link will peel during the process, as the two components have a similar hardness. This peeling can significantly reduce the strength of the assembly.

This problem can be solved if the pin, for example, is surface hardened, thus creating a difference in hardness with the link. Consequently, if a pin is surface hardened, assembly can be performed by driving the pin into a component of the same material that is not surface-hardened. This opens up new possibilities for assembling components of the same material, especially for Grade 5 Titanium which is the most commonly used titanium alloy, for which it is difficult to create a significant difference in hardness between a surface unhardened and through-hardened state.

Results of the driving-in test using a surface hardened pin or a surface unhardened pin driven in surface unhardened second parts are shown in the following Table 2. OK means reliable assembly, NOK means unreliable assembly.

TABLE 1
Summary of driving-in tests

| | Surface | Surface |
|---|---|---|
| | unhardened | unhardened |
| | link/surface- | link/surface |
| Material | hardened pin | unhardened pin |
| Grade 5 | OK | NOK |
| Titanium | | |
| Steel 904L | OK | — |

FIG. 6 schematically shows an assembly device 10 for pivotally attaching two parts 1, 2 of a watch according to the invention. The assembly device 10 comprises a first part 1 and a pin P. One side of the pin P which is the upper side in this example is rotatably connected to the first part 1. The other, lower side of pin P is mechanically connected to a second part which may or may not be part of the assembly device. For this purpose, the pin P has on its lower side means 7 for mechanical connection to the second part 2. The mechanical connection may generally be a connection restricting the degree of freedom along the pin but allowing the rotation of the pin itself around the pivoting axis. In particular, however, pin P is configured to be firmly attached or fixed inside an opening 21 of the second part 2. The opening 21 may be a blind hole, for example.

For example, the pin P may have a generally circular cross-section. In one of its end regions, pin P may comprise a cross-section which is not circular. For example, pin P may have a corrugated surface. Alternatively, the pin P may also have a circular cross-section in said end region in order to achieve a press-fit connection or a bonding connection with the second part 2.

Pin P has a second friction surface 5 in its upper region which has, in particular, an essentially circular cross-section. The first part 1 has a corresponding first friction surface 4. The first friction surface 4 and the second friction surface 5 are configured to pivotally guide one another during relative rotation between the first part 1 and the pin. The first friction surface 4 of the first part 1 is provided by an inner lateral surface of an opening 11 which is exemplarily configured as a blind hole.

The first friction surface 4 and the second friction surface 5 are configured such that one of the friction surfaces, for example the second friction surface 5 of the pin P, has a surface hardness which is higher than the hardness of silica and/or feldspar and the other friction surface, for example the friction surface 4 of the first part 1, has a surface hardness which is lower than the hardness of silica and/or feldspar.

In particular, the first friction surface 4 comprises a first material A and the second friction surface 5 comprises a second material B. One of the first and second materials A, B has a surface hardness H1 and the other one of the first and second materials A, B has a surface hardness H2. In particular, H1<Hm<H2, wherein Hm is the hardness of silica and/or feldspar. In particular, Hm is the hardness of silica and/or feldspar microparticles.

FIG. 7 shows a potential application of the invention in form of a part of a watch bracelet which is shown during assembly. The bracelet comprises several bracelet links M1, M2, M3 which are pivotally attached or articulated with one another. Additional bracelet links and/or other watch parts such as a watch case and/or a bracelet clasp which may be pivotally attached on the left-hand side and/or the right-hand side are omitted for clarity. Each bracelet link M1, M2, M3 comprises a first outer link part M1a, M2a, M3a, a second outer link part M1b, M2b, M3b and a central link part M1c, M2c, M3c between the respective outer link parts. In particular, all parts of a bracelet link M1, M2, M3 are firmly attached to one another so that each bracelet link M1, M2, M3 forms a rigid unit.

Each of the first and second outer link parts M1a, M2a, M3a, M1b, M2b, M3b has an opening for accommodating a section of the pin. In particular, the openings have a circular cross-section. The openings may be configured as blind holes. Alternatively, the openings on one of the outer link parts M1a, M2a, M3a, M1b, M2b, M3b may be configured as threaded holes and/or through holes in order to allow to receive a screw for so-called extension-links. The openings of the first and the second outer link parts of each bracelet link M1, M2, M3 are aligned such that two end regions of a straight pin or a screw can be accommodated therein.

Each of the central link parts M1c, M2c, M3c has an opening 11 for accommodating the central section of the pin. In particular, the opening 11 is a through hole so that the pin can be centrally held therein.

The watch bracelet shown on FIG. 7 comprises several assembly devices according to the invention. As shown by the brackets, the bracelet link M1 corresponds to a first part 1 and the bracelet link M2 corresponds to a second part 2. As the bracelet links M1, M2 overlap, also the brackets overlap. The first part 1 has a first friction surface inside the opening or through hole of its central link part M1c. The second part 2 holds both ends of the pin, in particular in a fixed manner, using its first and second outer link parts M2a, M2b. The pin comprises on its central circumferential surface the second friction surface 5.

In addition to the foregoing, the bracelet link M2 also corresponds to a first part and the bracelet link M3 corresponds to a second part, in respect to the pin located between M2 and M3. The first part 1 has a first friction surface inside the opening or through hole of its central link part M2c. The second part 2 holds both ends of the pin using its first and second outer link parts M3a, M3b. In a watch bracelet, this may repeat several times. Although most of the openings 11 and the pins P are hidden inside the construction, the opening 11 in the bracelet link M3 and the pin P in the bracelet link M1 are visible at the outer extremes of the shown bracelet part.

FIG. 8 shows a section of a rotatable attachment according to the invention, in particular through a plane indicated by line L of FIG. 7. It can be seen that pin P is mechanically connected to the second part 2, in particular with a first outer link part M3a and a second outer link part M3b, for example of a bracelet link M3 as shown in FIG. 7. Pin P has on its end portions, namely a first end portion 43 and a second end portion 44, means 7 for mechanical connection to the second part 2. Pin P may be free to rotate within the openings of the second part 2. However, in particular, pin P is fixed inside the openings in a rotationally fixed manner. This is usually performed by driving pin P into the openings to create a press-fit and/or form-fit attachment. In alternative, the pin P may be welded, brased, glued into the openings of the second part 2. In another alternative, the pin P may be locked in rotation by another element, such as a screw.

The central portion 41 of pin P runs through an opening, namely a through hole, of a first part 1, in particular a central link part M2c, for example of bracelet link M2. The circumferential outer surface of the central portion 41 forms the second friction surface 5 of the pin. The circumferential inner surface of the through hole forms the first friction surface 4 of the first part 1. During relative rotation of the first part 1 and the second part 2, the friction surfaces 4, 5 contact each other and guide each other.

FIG. 9 shows another embodiment of a pin P which is configured as a screw. In this case, pin P is not driven into the second part but screwed in. On its first end part 43 shown on the left-hand side the pin P comprises a screw head 40. In its opposite second end part 44 shown on the right-hand side, the pin comprises a threaded section 42 as a means 7 to be mechanically fixed inside an opening of a second part. Around a central portion 41, a first part 1 is arranged having the shape of a sleeve 6. A circumferential inner surface of the sleeve 6 which is in particular circular serves as the first friction surface 4 for pivotally guiding the pin P. The circumferential outer surface of the pin P serves as the second friction surface 5.

At the first end portion 43 of the pin, between the screw head 40 and the sleeve 6, seen in axial direction, there may be a portion without a sleeve. This portion may be configured to be mechanically connected or comprise means to be mechanically connected, e.g., fixed, in an opening of another part, e.g., the second part. For example, this portion of the pin P may be attached to a second part by press fit or by means of an additional component.

FIG. 10 shows an assembly device 10 similar to the assembly device 10 shown in FIG. 6 and described above to which reference is made. Only the differences to the configuration of FIG. 6 described in the following. The assembly device 10 of FIG. 10 has two pins P arranged coaxially on different axial positions of the axis of rotation. A section of the second part 2 is positioned between the two pins P. Also in this case, the second part 2 may or may not be part of the assembly device 10.

Each pin P has a side which is rotatably connected to the first part, namely the upper side of the upper pin P and the lower side of the lower pin P. the respective other sides are mechanically connected to the second part 2.

### LIST OF REFERENCE SIGNS

| | |
|---|---|
| First Part | 1 |
| Second part | 2 |
| First friction surface | 4 |
| Second friction surface | 5 |
| Sleeve | 6 |
| Means | 7 |
| Assembly device | 10 |
| Opening | 11 |
| Opening | 21 |
| Screw head | 40 |
| Central portion | 41 |
| Threaded section | 42 |
| First end portion | 43 |
| Second end portion | 44 |
| Pin | P |
| Bracelet link | M1, M2, M3 |
| First outer link part | M1a, M2a, M3a |
| Second outer link part | M1b, M2b, M3b |
| Central link part | M1c, M2c, M3c |
| Depth | D |
| Surface Hardness | HS |
| Bulk Hardness | HB |
| Disc | Di |
| Silica microparticles | S |
| Line | L |

The material whose surface hardness is higher than silica or feldspar and which may be a metal or a metal alloy is in particular surface-hardened. Surface-hardening makes the material particularly resistant to wear.

Using surface hardening provides further advantages. Standard materials can be used for bracelet components such as axes and links. Standard fabrication and assembly methods such as driving in a pin can be used. These methods in connection with surface hardening have shown to be well suited for a reduced wear in pivotal attached parts of a watch.

The materials which can be used are hypoallergenic and resistant to corrosion. Surface hardening is possible with materials which are not necessarily suitable for bulk hardening. Thus, a broader range of materials can be used. In particular, the surface-hardened material is a titanium alloy or an austenitic stainless steel.

Surface-hardened materials are easy to prepare in contrast to ceramics and bulk-hardened material, for example, since they can be machined before the surface-hardening process when the material is in a surface unhardened state. The machining of surface unhardened metal components saves time and cost. In addition, a reduced number of surface-hardened components is sufficient which, thus, also minimizes manufacturing costs.

Through the invention, an articulation assembly can be manufactured with a minimum number of components. Sleeves or inserts are not necessary. A maximum section of axes guarantees mechanical resistance and minimum profile of bracelets. Assembly is facilitated by driving in the axes into respective holes, e.g. of links.

The use of titanium alloys and austenitic stainless steels is advantageous due to their ability to be surface hardened, while keeping high bulk tenacity compared to ceramics and similar brittle materials.

In one configuration, the same material can be used for both parts, wherein one is surface-hardened and the other one is not. The bulk hardness of titanium alloys and austenitic stainless steels is below that of silica and/or feldspar and allows for microparticle incorporation to reduce tribological wear. The reduction is achieved by surface hardening of only one friction surface, typically an axe, which may be manufactured from the same material.

The hardening of the first friction surface instead of the second friction surface of the pin is advantageous as it can reduce at the same time the tribological wear of the articulation and the scratching of the outer surface of the link, preserving the esthetics of the bracelet by reduced scratching. In addition, using the same material for both friction surfaces allows for color similarity between surface-hardened and surface-unhardened components.

Using surface-hardening improves the ability to drive in a pin in comparison to bulk-hardening. This is due to the fact that the process reliability is increased since there is less risk of brittle failure of the pin. In summary, surface-hardening leads to a sort of a composite component having a relatively a soft metal core, having high tenacity, and a ceramic-like hard surface, having a high adhesion to the soft core, in order to reduce the tribological wear.

There is no need to use brittle bulk hard or brittle bulk hardened materials for at least one or both articulation components. There is no need to use additional sleeves and/or inserts to reduce the risk of rupture of hard and brittle components. Thus, the technical effort is reduced and manufacturing is facilitated.

1. An assembly device (10) for pivotally attaching at least two parts of a watch, the assembly device (10) comprising a first part (1) and at least a pin (P) having a means (7) to be mechanically connected to a second part (2), wherein the first part (1) has a first friction surface (4) and the pin (P) has a second friction surface (5), wherein the first friction surface (4) and the second friction surface (5) contact each other during pivoting movement,
wherein
one of the friction surfaces (4 or 5) has a surface hardness which is higher than the hardness of silica and/or feldspar and the other one of the friction surfaces (5 or 4) has a surface hardness which is lower than the hardness of silica and/or feldspar,
characterized in that the material forming the one of the friction surfaces (4, 5) having a surface hardness higher than that of silica and/or feldspar is a surface-hardened metal or metal alloy.

2. The assembly device (10) according to claim 1, characterized in that the pin (P) has the means (7) to be fixed inside an opening (21) of the second part (2).

3. The assembly device (10) according to claim 1, characterized in that the first part (1) comprises at least an opening (11) with an inner circumferential surface providing the first friction surface (4) and/or that the pin (P) comprises an outer circumferential surface providing the second friction surface (5).

4. The assembly device (10) according to claim 1, characterized in that the pin (P) comprises a screw head (40) on a first end portion (43) and a threaded section (42) on a second end portion (44).

5. The assembly device (10) according to claim 1, characterized in that the pin (P) comprises a central portion (41), a first end portion (43) and a second end portion (44), the first end portion (43) and the second end portion (44) being designed to be mechanically connected to the second part (2).

6. The assembly device (10) according to claim 1, characterized in that the first part (1) is configured as a sleeve (6) arranged around a section of the pin (P).

7. The assembly device (10) according to claim 1, characterized in that the first part (1) and/or the second part (2) is a bracelet link (M1, M2, M3).

8. The assembly device (10) according to claim 1, characterized in that the first part (1) or the second part (2) is a watch case.

9. The assembly device (10) according to claim 1, characterized in that the first part (1) or the second part (2) is a bracelet clasp.

10. The assembly device (10) according to claim 1, characterized in that the assembly device (10) further comprises the second part (2).

11. The assembly device (10) according to claim 1, characterized in that the one of the friction surfaces (4 or 5) having a surface hardness higher than that of silica and/or feldspar has a surface hardness of at least 800 HV 0.025.

12. The assembly device (10) according to claim 1, characterized in that the other one of the friction surfaces (5 or 4) having a surface hardness lower than that of silica and/or feldspar has a surface hardness of at most 500 HV 0.025, and of at least 120 HV 0.025.

13. The assembly device (10) of claim 1, characterized in that the second friction surface (5) of the pin (P) has the surface hardness which is higher than the surface hardness of silica and/or feldspar.

14. The assembly device (10) of claim 1, characterized in that the surface-hardened metal or metal alloy is one or more of surface-hardened titanium or titanium alloy, surface-hardened steel, or surface-hardened austenitic steel.

15. The assembly device (10) of claim 1, characterized in that the material forming the other one of the friction surfaces (4 or 5) having a surface hardness lower than that of silica and/or feldspar is one or more of surface-unhardened metal or metal alloy, surface-unhardened titanium or titanium alloy, surface-unhardened steel, surface-unhardened austenitic steel, or a precious metal alloy of a metal chosen from the group of Ag, Au, Pt and Pd.

16. A method for obtaining an assembly device (10) according to claim 1, the method comprising a treatment of a friction surface (4, 5) selected from thermal treatment, thermochemical treatment, ion implantation treatment and mechanical cold working.

17. The method according to claim 16, characterized in that the treatment is selected from nitriding, carburizing or nitrocarburizing heat treatment for surface hardening of steel, and a heat treatment with at least one element selected from oxygen, nitrogen and carbon for surface hardening of titanium alloy.

18. A bracelet comprising at least one assembly device (10) according to claim 1.

19. A watch comprising at least one assembly device (10) according to claim 1.

20. The watch according to claim 19, characterized in that the watch comprises a bracelet, wherein the assembly device (10) is part of the bracelet.
